(19) United States
(12) Patent Application Publication
(10) Pub. No.: US 2022/0074152 A1
(43) Pub. Date: Mar. 10, 2022

(54) AN APPARATUS FOR HANDLING LOOSE MATERIAL

(71) Applicant: KISS TECH PTY LTD, Lethbridge, Victroria (AU)

(72) Inventors: Ronald Keith O'CONNOR, Lethbridge (AU); Garry Maxwell BAUM, Lethbridge (AU)

(21) Appl. No.: 17/417,698

(22) PCT Filed: Dec. 12, 2019
(86) PCT No.: PCT/AU2019/000151

§ 371 Date: Jun. 23, 2021

(30) Foreign Application Priority Data
Dec. 24, 2018 (AU) 2018904939

(51) Int. Cl. E01H 1/05; A01D 34/416; A01D 34/66; A01D 34/74; E01H 5/09

(52) U.S. Cl. CPC E01H 1/053; A01D 34/416; E01H 5/092; A01D 34/74; A01D 34/66

(57) ABSTRACT

Disclosed herein is an apparatus for handling loose material being mounted to or mountable on a forward end of a prime mover, the apparatus having a frame which is configured to suspend a plurality of rotary tools therefrom for cutting and/or moving material and at least one tool being configured so as to be able to direct the material in a pre-determined direction relative to a forward movement of the prime mover.

### RELATED APPLICATIONS

This application claims priority to Australian provisional application no. 2018904939 filed on 24 Dec. 2018, the content of which is incorporated herein by reference in its entirety.

### FIELD OF THE INVENTION

This invention relates to an apparatus for handling loose material being mounted to or mountable on a forward end of a prime mover.

### BACKGROUND

The efficient cleaning of work surfaces, whether internal or external, can be important for the purposes of hygiene, cleanliness, effectiveness of movement and/or safety.

When rearing domestic animals, such as pig, cows, poultry, including chickens and the like, these animals are often housed indoors, and their enclosures must be kept clean and as sterile as possible to prevent sickness and disease. In particular, chickens can be extremely susceptible to such sickness, and the improper maintenance of a chicken enclosure or shed can lead to the high mortality rate and therefore wastage and reduced cost-efficiencies. Therefore, the animal enclosures are usually thoroughly cleaned and sterilised between each batch which is usually time-consuming and involves significant labour costs.

Furthermore, in external areas which can be constantly inundated with substantial amounts of materials such as snow, sand or dirt, grass cuttings, the build-up of these materials on roads, footpaths, car parks, working areas and the like can greatly affect the effectiveness of movement and/or safety of the residents or workers in that area. Examples of such external areas include coastal areas where sand can be blown about public or working areas, the mining industries where the collection of fine materials produced by the processing of ores is sufficiently valuable to ensure that it is collected efficiently and effectively, and snow-prone areas which experience harsh winters. Furthermore, snow can also melt and re-freeze into ice which can present a significant safety hazard. Thus it is important to clear these areas quickly and effectively to prevent the risk of injury, to collect valuable materials, and allow residents or employees to regain access. Facilities, such as ski resorts, will also require snow clearing to provide a high level of service to their users. The build-up of these materials is typically cleared by manually shovelling or sweeping the area, which is also time-consuming.

Mechanical sweepers or brooms having multiple brushes which are attachable to the front of a vehicle, such as a skid-steer loader or front-end loader, have been used for sweeping surfaces however these currently suffer disadvantages in that the broom heads, in particular the lead broom head, can be easily damaged, especially when manoeuvring between the internal columns of an animal enclosure or structures mounted about car parks, foot paths or roads.

Examples of the invention seek to solve or at least ameliorate one or more disadvantages of previous apparatus for cleaning surfaces.

The above references to and descriptions of prior proposals or products are not intended to be, and are not to be construed as, statements or admissions of common general knowledge in the art. In particular, the above prior art discussion does not relate to what is commonly or well known by the person skilled in the art, but assists in the understanding of the inventive step of the present invention of which the identification of pertinent prior art proposals is but one part.

### SUMMARY OF THE INVENTION

According to the present invention there is provided an apparatus for handling loose material being mounted to or mountable on a forward end of a prime mover, the apparatus having a frame which is configured to suspend a plurality of rotary tools therefrom for cutting and/or moving material and at least one tool being configured so as to be able to direct the material in a pre-determined direction relative to a forward movement of the prime mover.

Preferably, the apparatus is configured such that at least one tool is resiliently connected to the frame for absorption of stresses and shocks.

According to an embodiment, the at least one tool is the forward-most tool in the direction of forward travel of the prime mover.

According to an embodiment, the resilient connection includes biasing means in the form of a coil spring.

According to an embodiment, the apparatus is configured such that the tool are suspended at an angle relative to the horizon for optimising tool contact with a ground surface.

According to an embodiment, the tools are tipped in a sidewards direction or forwards direction to the direction of travel of the prime mover.

According to an embodiment, the tools are tipped at about 5° to the horizon.

According to an embodiment, the angle of each tool is independently adjustable.

According to an embodiment, the apparatus is configured such that the torque speed of each tool is independently adjustable.

Preferably, the adjustability is driven by hydraulic or electric-powered device so as to facilitate remote operation.

Preferably, the tools are brushes. More preferably, the forward-most tool comprises means for cutting or trimming. The means for cutting or trimming is a rotary flexible monofilament.

According to an embodiment, the apparatus is configured to accommodate larger brushes or larger brush heads.

According to an embodiment, the mounting of at least one tool includes a link or links, wherein the link(s) has an upwardly protruding bend.

According to an embodiment, the brushes rotate in the same direction for moving loose material on a surface from one brush to another until the material is delivered to a side of the apparatus.

According to an embodiment, at least one brush on a side of the apparatus rotates in an opposite direction relative to at least one brush on the opposite side of the apparatus so as to direct the loose material inwardly and/or under the apparatus.

Preferably, the apparatus has means for suppression of dust. More preferably, the means for suppression of dust comprises at least one water dispensing device for dispensing providing a mist or jet of water.

According to an embodiment, the apparatus includes means for guiding the loose material and reducing scatter thereof. Preferably, the means for guiding the loose material includes a guide member having a vertical face substantially parallel to the or a pre-determined intended direction of travel of loose material.

### BRIEF DESCRIPTION OF THE DRAWINGS

The present invention will now be described, by way of non-limiting example, with reference to the accompanying drawings in which:

FIG. 1 is a perspective view of an apparatus for handling loose material according to a preferred embodiment of the present invention;

FIG. 2 is a top view of part of the apparatus of FIG. 1;

FIG. 3 is a detailed view of a resilient connection between a forward-most brush and a frame of the apparatus of FIG. 1;

FIGS. 4 and 5 are front and side views of a brush and its mounting connection to the frame;

FIGS. 6 and 7 are front and side views of a bracket for the connection of FIGS. 4 and 5;

FIG. 8 shows a top view of the apparatus for handling loose material having five brushes in an operational mode according to another preferred embodiment of the invention;

FIG. 9 shows a close up partial view of the apparatus of FIG. 8 having a pivotal connection which allows the brushes to be moved into a compact configuration;

FIG. 10 shows a top view of the apparatus of FIG. 8 in a compact configuration;

FIG. 11 shows a close up partial view of the apparatus of FIG. 10;

FIG. 12 is a front perspective view of an apparatus for handling loose material according to yet another preferred embodiment of the present invention; and

FIG. 13 is a partial close up view of the apparatus of FIG. 12.

### DETAILED DESCRIPTION OF THE INVENTION

Preferred features of the present invention will now be described with particular reference to the accompanying drawings. However, it is to be understood that the features illustrated in and described with reference to the drawings are not to be construed as limiting on the scope of the invention.

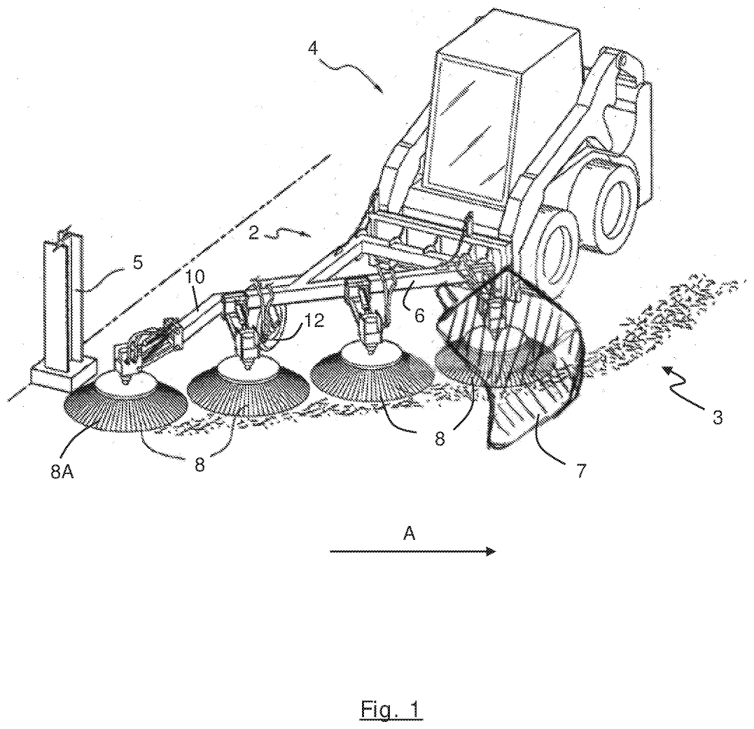

FIGS. 1 to 13 illustrate an apparatus 2, 102, 202 for handling loose material 3, 203 according to preferred embodiments of the present invention. The apparatus 2, 102, 202 is configured to be mounted to or mountable to a prime mover 4, such as a Bobcat, as illustrated in FIG. 1. Such prime movers 4, 204 are well-known for material handling and for being adapted for equipment mounting on the front thereof. It also can have a hydraulic system from which pressure hydraulic fluid can be obtained and which may be used in the apparatus 2, 102, 202. The prime mover 4, 204 may also have an air-conditioned cabin for protecting the user from dust or dirt inhalation, and the protection of elements such as extreme heat or cold.

The apparatus 2, 102, 202 has a frame which is adapted to be connectable to the front of the prime mover. The frame has a bar 6, 106, 206 which carries a number of brushes 8, 108, 208 for the handling of material along its longitudinal length. At the end of the bar 6, 106, 206 there is an extension 10, 110, 210 to which a brush is connected, and which has a caster wheel 12, 212 thereunder for supporting the frame.

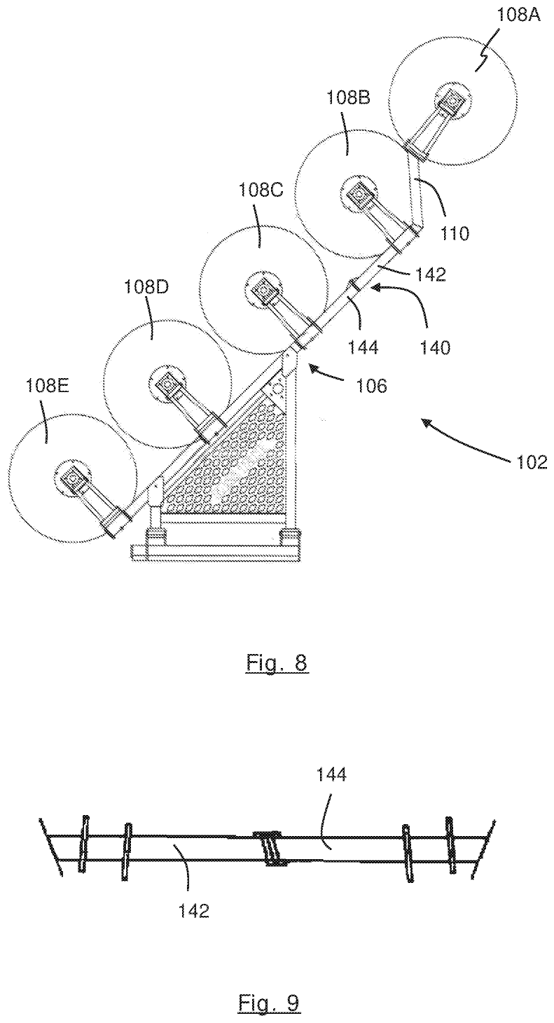

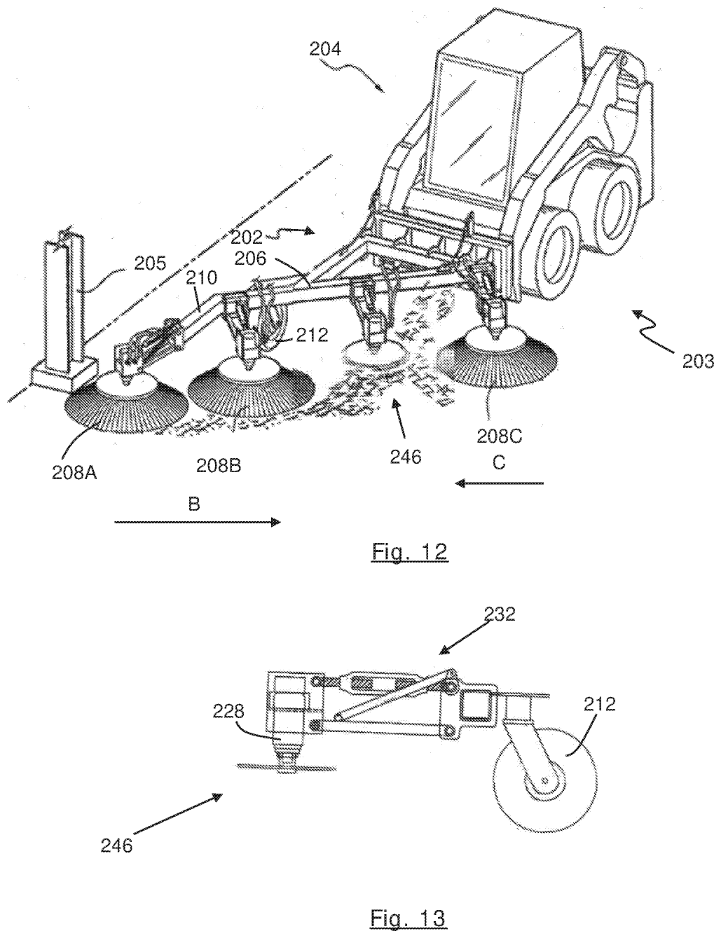

As illustrated in FIGS. 1 to 13, the brushes 8, 108, 208 are circular brushes and are configured to be driven by a source of power, such as hydraulic motors. The brushes 8, 108, 208 may be made of synthetic fibres, and alternatively made be made of wire depending on the material to be handled. The brushes 8, 108 are preferably driven in the same direction but in some arrangements the brushes 208 may be configurable to rotate in opposing directions for better handling of material as will discussed in more detail in the paragraphs below with reference to FIGS. 12 and 13. As exemplified in FIG. 1, there are four brushes 8, however there may be three or five or more brushes as required to handle the material appropriately. FIGS. 8 to 11 particularly illustrate an apparatus 202 having five brushes 208A-E.

The frame is adapted to be foldably connected to the prime mover 4, 204 via a hinge to allow the frame to be foldable and unfoldable relative to the prime mover 4, 204. In the folded configuration, the frame is held above the ground thereby preventing damage to the frame during transport, while in the unfolded configuration, the brushes 8, 108, 208 are in contact with the ground for handling the material 3, 203.

The bar 6, 106, 206 extends at least across the front width of the prime mover 4, 104, 204 and is angled to the direction of forward movement. As illustrated in FIGS. 1 to 11, the brushes 8, 108 are arranged such that each brush 8, 108 is set rearwardly and adjacent to a side of the brush preceding it, such that the brushes 8, 108 are arranged in a line which is angled to the direction of forward movement. Such an arrangement allows the material 3 handled to be delivered to one side.

As the prime mover 4 moves forwardly, the material 3 is advantageously deposited in a windrow to a side of the prime mover 4 as illustrated in FIG. 1. The bar 6 can include a guide member which is configured for assisting in the formation of the windrow and preventing and/or reducing scatter of the material 3. In a preferred embodiment shown in FIG. 1 the guide member 7 has a vertical face which is substantially parallel to the direction of travel and thereby assists in reducing outward scatter of the material 3. The guide member 7 has a bottom edge which is held above the ground so as not to disrupt the movement of the prime mover 4. In a more preferred embodiment, the guide member 7 is hingedly connected to the bar 6 so that the guide member 7 can be moved away from the ground for allowing access to the brushes 8 adjacent thereto for maintenance or servicing.

The extension 10 as illustrated in FIG. 1 can also include a resilient connection 14 such that the forward-most brush 8A is resiliently connected to the frame for absorption of shocks and stresses. For example, in chicken enclosures, it is often necessary to clean closely around the frame or internal columns to ensure that the chicken enclosure is of sufficient cleanliness to prevent infection. A similar situation exists in handling materials along roads, footpaths, mines and other structures where the areas about posts, lamps, mail boxes, barriers must also be cleared of material. Unfortunately, the forward-most brush 8A can then be vulnerable to damage while cleaning between or around those structures. The resilient connection 14 advantageously assists to prevent damage to the forward-most or leading brush 8A, as well as the brush mounting connection but also to assist effective handling of material 3, as the two forward-most brushes are positioned closer together thereby promoting better handling of the material 3 between structures when the resilient connection 14 is at its most compressed state.

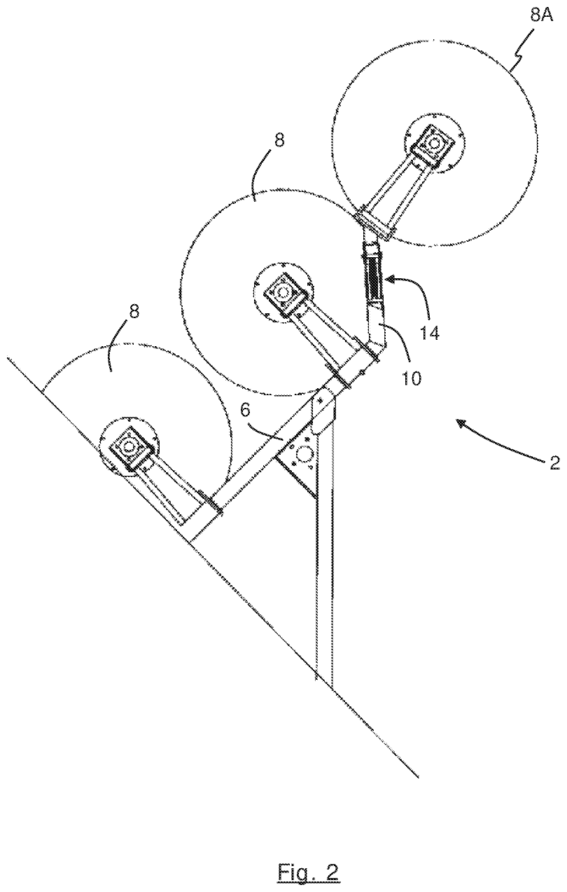

While the resilient connection 14 is shown in the extension between the end of the bar 6 and the forward-most brush 8A in FIGS. 1 and 2, it is envisaged that this arrangement could be applied to any and all brushes 108, 208 in other embodiments.

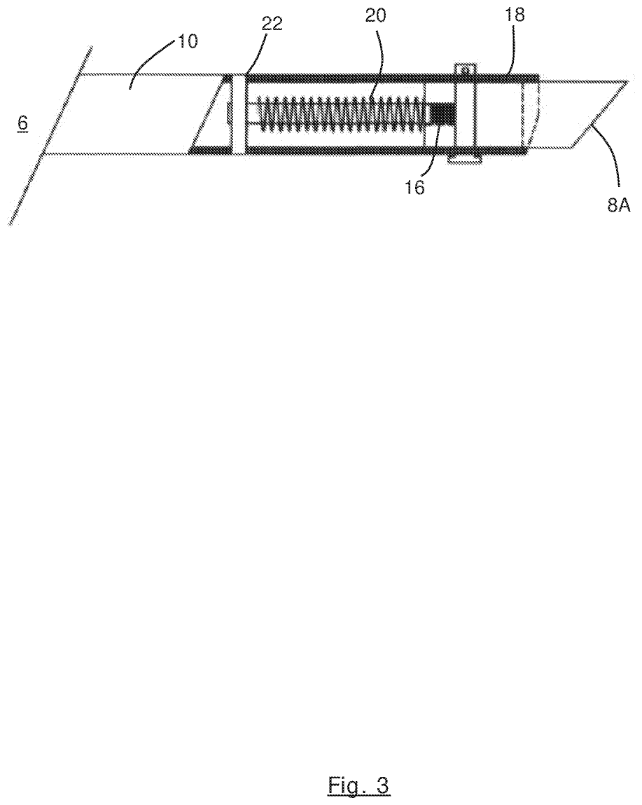

The resilient connection 14 is in the form of a central rod 16 co-axially aligned with a hollow cylindrical shell 18. The shell 18 is movable along the rod 16 and has a biasing means 20 therebetween for absorbing stress and shock. In FIGS. 2 and 3, the biasing means 20 is a coil spring also co-axially aligned with the central rod 16 therein which can engage a plate 22 rigidly fixed to an end of the central rod 16 and which is compressible thereon to dampen the shocks and stresses. Alternatively, the biasing means 20 can be fluid-based such as that provided by the rod 16 engageable by a hydraulic cylinder. In another embodiment, the biasing means 20 can be a combination of a fluid-based biasing means and a spring.

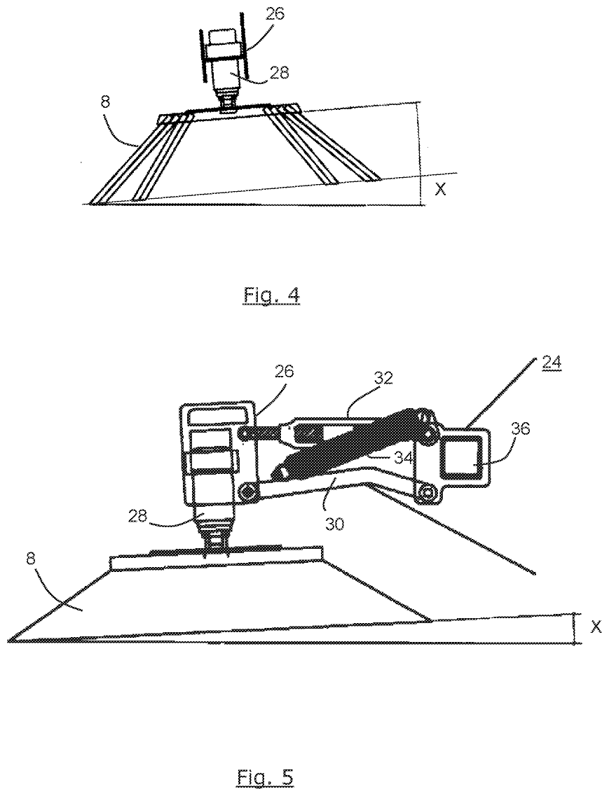

Each of the brushes 8, 108, 208 is pivotally connected to the bar 6, 106, 206 via a connection having a pair of brackets 24 a mount 26 for carrying the hydraulic motor 28, 228 for driving the brush, and a pair of lower links 30 attached therebetween as illustrated in FIGS. 4 to 7 and FIG. 13. The connection also has an adjustable link 32, 232 in the form of a turnbuckle between the brackets and the hydraulic motor mount for adjustment of the up and down movement of the brush position relative to the bar 6, 106, 206 and a spring 34 to limit downward movement of the brushes. By lengthening the turnbuckle 32, 232 each individual brush angle can be steepened to lessen the contact area between the brush 8, 108, 208 and the ground surface thereby adjusting the aggressiveness of the brush 8, 108, 208 however this can shorten the life of the brush 8, 108, 208. Similarly, by shortening the turnbuckle 32, 232 each individual brush angle can be made more shallow thereby increasing the contact area, creating a larger sweeping area and extending the life of the brush 8, 108, 208.

In a preferred embodiment, the adjustable link 32 can be a hydraulic or electric cylinder which is remotely operable by the user in the cabin of the prime mover 4, 204. This allows the user to quickly adjust the brush position and movement without exiting the cabin.

The lower links 30 preferably are arranged to accommodate larger or different types of brushes which can have bristles which extend close to the connection. The lower links 30 can have an upwardly projecting bend, where each end of each link is angled upwardly from its attachment at either the brackets 24 or hydraulic motor mount 26. This bend particularly and advantageously increasing the space under the brush connection which allows the accommodation of larger brushes and also allows accommodation of different brush angles. Each hydraulic motor 28, 228 can also be driven independently from each other and the torque speed provided by each motor 28, 228 is also adjustable for optimum material handling and to accommodate different types and sizes of brushes. The oil for the hydraulic motors 28, 228 can be preferably supplied from the hydraulic system of the prime mover 4, 204 or alternatively is independently supplied.

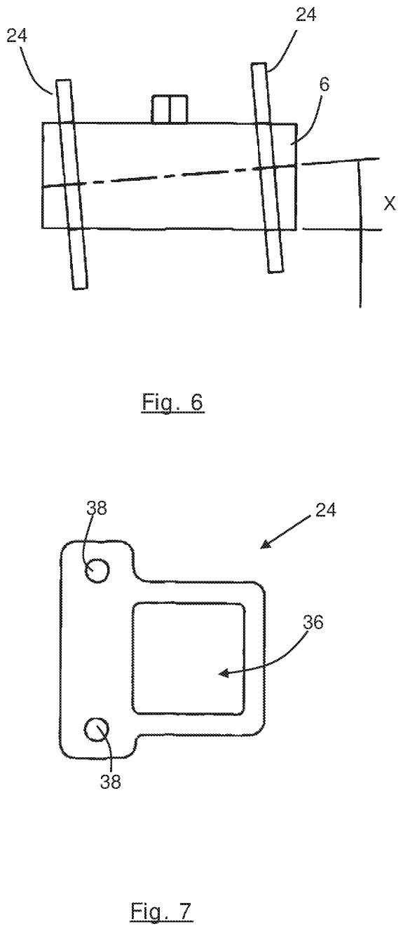

The attachment of the brackets 24 to the bar 6 is adjusted such that the angle X of the brush 8 (labelled in FIGS. 4 and 5 as ‘X’) can be adjusted for optimum handling of material 3, 203 and improved brush contact with the ground. The applicant has found that an angle X of between 5° to 10° greatly improves the brush contact, and that in particular an angle X of about 5° is even more preferred. Each bracket 24 has an opening 36 which is configured to allow the bar 6 to be inserted therethrough and has a tab portion having apertures 38 which allow the threading of bolts to connect the links 30, 32, such as the lower links and turnbuckle. The tab portion and opening 36 are aligned to be offset such that the pair of spaced-apart brackets, where one bracket is vertically inverted with respect to the other and receiving the bar 6 within the openings therethrough incline the brush mounting (see FIG. 6) and thereby the brush at the optimum angle of 5°. The angle of the brush mounting can be adjusted by changing the offset alignment of the tab portion and consequently the apertures 38 with the opening 36.

In an example use of the apparatus 2, the apparatus 2 is mounted onto the prime mover 4 if not already connected and any hydraulic lines which need to be connected are then connected. The frame can be in the folded configuration while the apparatus 2 is being transported to the worksite and then unfolded such that the wheel 12 can support the frame and the brushes 8 are in contact with the ground. The individual positions of the brushes 8 can be set by the adjustable links 32, and the angle of the brushes 8 can also be set by the particular arrangement of the alignment of the opening 36 and apertures 38 of the brackets 24.

As the apparatus 2 is operated and is moved forwardly by the prime mover 4, the material 3 which lays loose on the ground is picked up by the brushes and moves across to one side in the substantial direction indicated by the arrow A in FIG. 1 where it is picked up by the adjacent brush 8 until the last brush 8 where the material 3 is delivered to one side.

As the forward-most broom 8A extends beyond the side of the prime mover 4, the brush 8A can pass closely between and along the side of structures 5 in the work area. As the forward-most brush 8A bumps or brushes the side of the structures 5, the shock and stress is absorbed by the resilient connection 14 and prevents damage to the brush 8A.

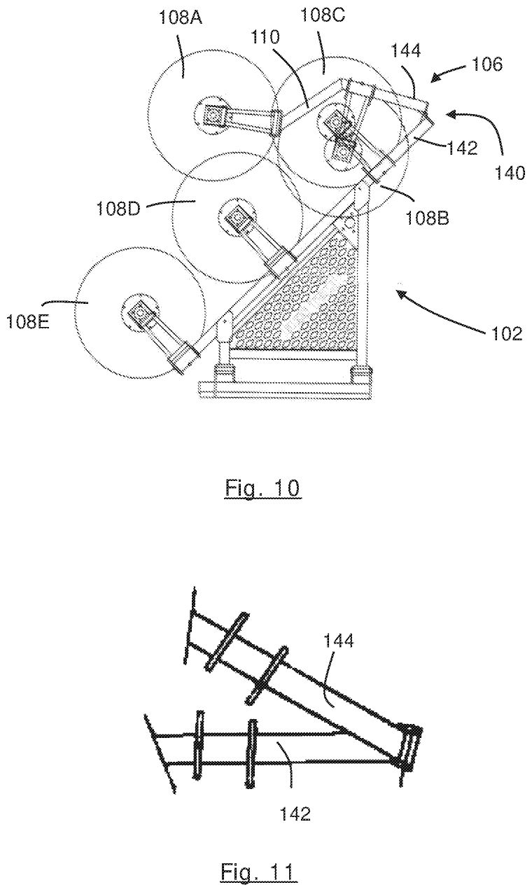

Referring now to FIGS. 8 to 11, there is shown another apparatus 102 according to another preferred embodiment of the invention having five brushes 108. The apparatus 102 operates similarly to apparatus 2 as described above, and similar items have similar reference numbers separated by a multiple of 100. Having five brushes 108 advantageously is more effective at handling more loose material however the five brushes 108 are obviously wider and therefore maybe more difficult to transport, for example in a truck, or there be difficulties fitting around or through structures such as beams or doors. The frame 106 is therefore configured so as to be foldable relative to itself such that the apparatus 102 can be manipulable between two configurations; a configuration in which the apparatus 102 is operable and a compact configuration for transporting the apparatus 102. In a preferred embodiment, the bar 106 of the frame has two portions 142, 144 which are connectable by a pivotal connection 140 where the portion 142 supports brushes 108A and 108B, and portion 144 supports brushes 108C to E. As illustrated in FIG. 10, the apparatus 102 is pivotal into a compact configuration where brushes 108A and 108B are held spaced-apart vertically above 108C and 108D thereby having a narrower profile which allows for easier transport and movement of the apparatus 102.

In FIGS. 12 and 13, there is shown another apparatus 202 for handling loose material according to yet another preferred embodiment of the invention. The apparatus 202 operates similarly to apparatus 2, 102 as described above, and similar items have similar reference numbers separated by a multiple of 100. The apparatus 202 is similar to apparatus 2 in that it is configured to support four brushes however in this apparatus 202 one brush has been removed leaving a brush-less section 246 as illustrated in FIG. 13. The apparatus 202 is also configured such that the brushes 208A and 208B rotate in an opposite direction to brush 208C so as to direct the loose material 203 inwardly.

For example, brushes 208A and brushes 208B rotates in an anti-clockwise direction so as to direct the loose material 203 in the direction of arrow B, while the brush 208C rotates in a clockwise direction so as to direct the loose material 203 in the direction of arrow C. In particular, the loose material 203 is directed inwardly and under the path of the forwardly moving prime mover 204. This apparatus 202 has the advantage of being able to direct the loose material 203 in a way that reduces the effect on others nearby. For instance, in the case of handling loose material around moving vehicles or other people, such as cut grass, gravel, snow or other debris, directing the loose material 203 to the side of the prime mover 204 may affect the movement of traffic and people and may cause a safety hazard.

The apparatus 2, 102, 202 can also include safety structure (not shown) for prevention of injury to a person in proximity of the apparatus 2, 102, 202 when it is in use and/or in motion. The safety structure can be provided spaced-apart vertically and forwardly from the bar 6 and/or brushes 8 so as not to interfere with its operation. Preferably, there is no safety structure about the forward-most brush 8A as this would obstruct its ability to sweep at the corners or under structures. In a preferred embodiment, the safety structure can be in the form of a cover or rails which is configured to arrest a person's movement before the apparatus 2, 102, 202 contacts the person.

In preferred embodiments, the apparatus 2, 102, 202 can include means for suppression of dust and other air-borne particulate matter (not shown in the Figures). As the apparatus 2, 102 handles the loose material 3, 203, particulate material 3 in the form of dust can be made airborne. The means for suppression of particular matter can be in the form of water dispersion devices, and preferably, the apparatus 2, 102 can have a water dispersion device provided at each brush 8, 108, 208. The water dispersion device can be a nozzle which dispenses a fine mist or jet or water which can catch and wash the dust onto the ground. The water can be held in a reservoir on the prime mover 4, 204 and then pumped to the or each nozzle on the brushes 8, 108, 208. In the above embodiments, the apparatus 2, 102 and 202 can also be configured for facilitating removal of groundcover or grasses at the side of a road or other structure. In particular it can be appreciated that the forward-most brush, 8A, 108A and 208A may be replaced with means for cutting or trimming. As such, the brush 8A, 108A and 208A can cut the groundcover or grass, while the other brushes can facilitate removal of the material so as to form a windrow for easy collection. The means for cutting or trimming can comprise a flexible monofilament which rapidly rotates to cut or trim groundcover or grass. Alternatively, the means for cutting or trimming can comprise a metal blade.

Through-out the specification and claims the word “comprise” and its derivatives is intended to have an inclusive rather than exclusive meaning unless the context requires otherwise.

Orientational terms used in the specification and claims such as vertical, horizontal, top, bottom, upper and lower are to be interpreted as relational and are based on the premise that the component, item, article, apparatus, device or instrument will usually be considered in a particular orientation, typically with the assembly uppermost.

It will be appreciated by those skilled in the art that many modifications and variations may be made to the methods of the invention described herein without departing from the spirit and scope of the invention.

1-19. (canceled)

20. An apparatus for handling loose material being mounted to or mountable on a forward end of a prime mover, the apparatus having a frame which is configured to suspend a plurality of rotary tools therefrom for cutting and/or moving material and at least one tool being configured so as to be able to direct the material in a pre-determined direction relative to a forward movement of the prime mover, wherein:
the at least one tool is pivotally connected to the frame via a connection including one or more brackets attachable to the frame and an adjustable link for adjustment of upward and downward movement of the tool relative to the frame;
adjusting the adjustable link causes the at least one tool to tip relative to a ground surface;
the one or more brackets are attachable to the frame to tip the at least one tool relative to the ground surface; and
the adjustable link and/or the one or more brackets are adapted to tip the at least one tool in a forwards and/or sidewards direction to the relative to the forward movement of the prime mover, at an angle between about 5 degrees and about 10 degrees relative to the ground surface.

21. An apparatus according to claim 20, wherein two or more of the plurality of tools are each pivotally connected to the frame and independently operable so that each of the tools is able to be tipped in the forwards and/or sidewards direction.

22. The apparatus according to claim 20, wherein the adjustable link and the one or more brackets are together adapted to tip the at least one tool in the forwards and/or sidewards direction in a range of angles between about 5 degrees and about 10 degrees relative to the ground surface.

23. The apparatus according to claim 20, wherein the adjustable link and/or the one or more brackets are adapted to tip the at least one tool in the forwards and/or sidewards direction about 5 degrees relative to the ground surface.

24. The apparatus according to claim 20, wherein the adjustable link and the one or more brackets are each adapted to decrease or increase the contact area between the at least one tool and the ground surface to optimise tool contact with the ground surface.

25. The apparatus according to claim 20, wherein the one or more brackets comprise a pair of brackets that are configured such that when one bracket is vertically inverted with respect to the other bracket, the connection comprising the pair of brackets causes tipping of the tool in the forwards and/or sidewards direction.

26. The apparatus according to claim 25, wherein each bracket includes a frame attachment portion and a tab portion to connect to the at least one tool, and the frame attachment portion and the tab portion are aligned to be offset.

27. An apparatus according to claim 20, wherein the apparatus is configured such that at least one tool is resiliently connected to the frame for absorption of stresses and shocks.

28. An apparatus according to claim 27, wherein the at least one tool is the forward-most tool in the direction of forward travel of the prime mover.

29. An apparatus according to claim 28, wherein the resilient connection includes a biasing mechanism in the form of a coil spring.

30. An apparatus according to claim 28, wherein the biasing mechanism is integrated into the frame.

31. An apparatus according to claim 28, wherein the biasing mechanism is integrated into an extension between a bar of the frame and the forward-most tool.

32. An apparatus according to claim 20, wherein the apparatus is configured such that a torque speed of each tool is independently adjustable.

33. An apparatus according to claim 20, wherein the at least one tool is a brush.

34. An apparatus according to claim 28, wherein the forward-most tool comprises material for cutting or trimming.

35. An apparatus according to claim 34, wherein the material for cutting or trimming is a rotary flexible monofilament.

36. An apparatus according to claim 33, wherein the apparatus is configured to accommodate brushes or brush heads that have bristles which extend close to the connection.

37. An apparatus according to claim 36, wherein the connection of the at least one tool includes a link or links, wherein the link(s) has an upwardly protruding bend to accommodate the brushes or brush heads.

38. An apparatus according to claim 20, wherein the plurality of tools is a plurality of brushes, and the brushes rotate in the same direction for moving loose material on the ground surface from one brush to another until the material is delivered to a side of the apparatus.

39. An apparatus according to claim 20, wherein the plurality of tools is a plurality of brushes and at least one brush of the apparatus rotates in an opposite direction relative to at least one other adjacent brush of the apparatus so as to direct the loose material inwardly and/or under the apparatus.
